(19) United States
(12) Patent Application Publication
(10) Pub. No.: US 2005/0035181 A1
(43) Pub. Date: Feb. 17, 2005

(54) Package substrate and process thereof

(76) Inventors: Kenny Chang, Hsin-Tien City (TW); Chi-Hsing Hsu, Hsin-Tien City (TW)

Correspondence Address: J C PATENTS, INC., 4 VENTURE, SUITE 250, IRVINE, CA, 92618, US

(21) Appl. No.: 10/714,336

(22) Filed: Nov. 13, 2003

(30) Foreign Application Priority Data
Aug. 14, 2003 (TW) 92122340

(51) Int. Cl. B23K 31/02

(52) U.S. Cl. 228/180.5; 228/180.21

(57) ABSTRACT

A manufacturing process of package substrate is disclosed. The process is firstly disposing at least one passive component between a power pad and a ground pad of a package substrate, wherein two electrodes of the passive component connecting to the power pad and the ground pad, respectively; and then forming a metal layer on the electrodes of the passive component and exposed surfaces of all the conductive pads of the substrate. Therefore, during the subsequent wire bonding process, the two ends of the conductive wire can be respectively connected to a die pad of a die and an electrode of the passive component for improving yield and reliability of chip package fabrication.

### CROSS-REFERENCE TO RELATED APPLICATION

This application claims the priority benefit of Taiwan application Ser. No. 92122340, filed on Aug. 14, 2003.

### BACKGROUND OF THE INVENTION

1. Field of the Invention

The present invention relates to a chip package and process thereof; more particularly, the present invention relates to a package substrate and process thereof for a wire bonding type package.

2. Description of the Related Art

Because of the evolution of the semiconductor technology and the market requirement, the semiconductor industry has developed high integrated and high speed electronic devices. For the semiconductor package technology, for example, chip package technology, the manufacturing of chip carriers and the assembly of the passive components are all very important in the semiconductor industry.

For the chip package technology, a die generated from performing semiconductor manufacturing processes over a wafer and by cutting the wafer, is assembled on a surface of a carrier by, for example, a wire bonding technology or a flip chip bonding technology, wherein the carrier is, for example, a leadframe or a substrate. The die has many die pads; therefore, the die can be electrically connected to the external electronic devices by connecting the die pads of the die to the transmission circuits and contacts of the carrier. In addition, after the die pads of the die are electrically connected to the contacts of the carrier by a wire bonding technology, a dielectric material can cover the die and conductive wires for protecting the die and the conductive wires. Therefore, a manufacturing process of chip package is complete and a chip package is formed thereby.

FIGS. 1A˜1C are a schematic process flow illustrating a conventional manufacturing process of a wire bonding type package with a passive component. Please referring to FIG. 1A, a carrier 110 is provided, which has a die bonding area 112, and at least a power pad 116, a ground pad 114 and a signal pad 118 are disposed on the surface of the carrier 110 outside the die bonding area 112. In addition, the signal pad 118 is disposed farther from the die bonding area 112 than the power pad 116 and the ground pad 114. The power pad 116, the ground pad 114 and the signal pad 118 are formed, for example, by a patterned conductive layer, and the surface of the patterned conductive layer can be covered with a patterned solder mask layer 140. The solder mask layer 140 has a plurality of openings 142 which expose the surfaces of the power pad 116, the ground pad 114 and the signal pad 118 respectively. In addition, in order to prevent the oxidation of pads 114, 116 and 118, a metal layer 144 is formed on the exposed surfaces of the power pad 116, the ground pad 114 and the signal pad 118. The material of the metal layer 244 can be, for example, nickel, gold or alloy thereof. Therefore, the reliability of a subsequent wire bonding process can be improved.

Referring to FIG. 1B, a die 120 is disposed on the surface of the carrier 110, and bonded on the die bonding area 112 with the backside 122 of the die 120. The active surface 124 of the die 120 has a plurality of die pads 126

Referring to FIG. 1C, two ends of each conductive wire 134, 136 and 138 are connected to one of the die pads 126 of the die 120 and to the power pad 116, the ground pad 114 and the signal pad 118, respectively. In addition, in order to improve the electrical performance of the chip package 100, a small passive component 130 is usually used to be bonded on the surface of the carrier 110 by surface mount technology (SMT) for reducing signal noise crosstalk and maintaining signal transmission quality. The passive component 130 can be, for example, an inductor or a capacitor. The passive component 130 is disposed between the power pad 116 and the ground pad 114 of the carrier 110, and two electrodes 132a and 132b of the passive component 130 are soldered to the power pad 116 and the ground pad 114, respectively.

Referring to FIG. 1C, it should be noted that the passive component 130 is disposed, for example, under the signal conductive wire 138, and the signal conductive wire 138 is over the passive component 130 and does not touch the electrode 132a. However, the conductive wire 136 connected to the die pad 126 and the power pad 116 must be over the passive component 130, and is then bonded to the surface of the power pad 116. Because the conductive wire 136 must be an arc for crossing over the passive component 136, the length of the conductive wire 136 increases, so the length of signal transmission path increases. Therefore, the electrical performance of the die 120 becomes worse and the layout space of neighboring conductive wires is affected.

### SUMMARY OF THE INVENTION

Accordingly, one object of the present invention provides a manufacturing process of package substrate in order to improve yield and reliability of a subsequent wire bonding process.

In order to achieve the object of the present invention mentioned above, the present invention discloses a manufacturing process of package substrate comprising providing a carrier, a surface of the carrier having a die bonding area; forming a patterned conductive layer on the surface of the carrier, wherein the patterned conductive layer at least comprises a power pad, a ground pad and a signal pad; then disposing at least one passive component between the power pad and the ground pad, the passive component having at least two electrodes which are separately electrically connected to the power pad and the ground pad; and finally forming a metal layer on surfaces of the electrodes and exposed surfaces of the power pad, the ground pad and the signal pad.

In order to make the aforementioned and other objects, features and advantages of the present invention understandable, a preferred embodiment accompanying figures is described in detail as follow.

### BRIEF DESCRIPTION OF THE DRAWINGS

FIGS. 1A˜1C are a schematic illustrating the progression of a conventional manufacturing process of a wire bonding type package.

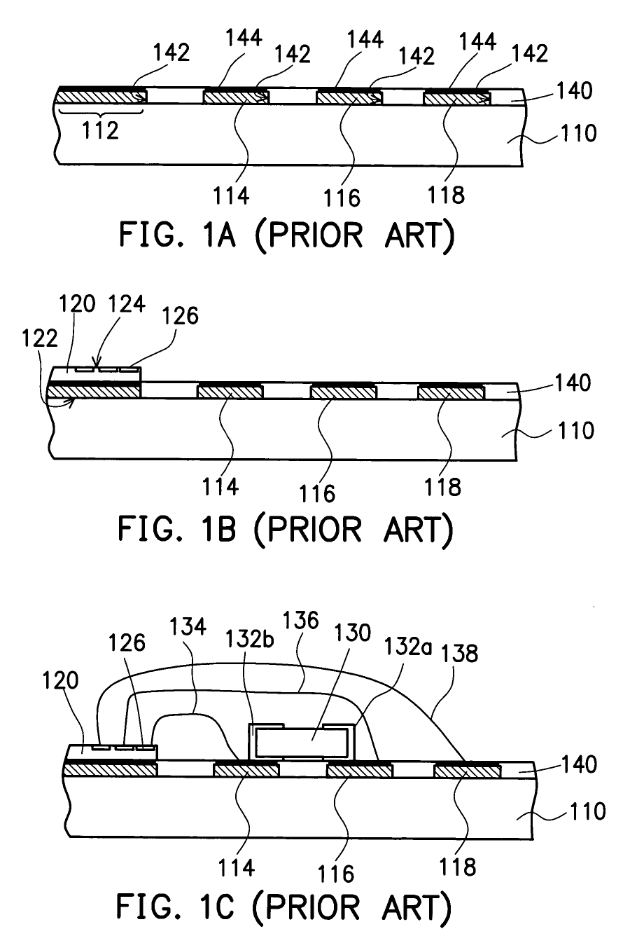

FIGS. 2A˜2C are a schematic illustrating the progression of a manufacturing process of a wire bonding type package in accordance with the present invention.

### DESCRIPTION OF SOME EMBODIMENTS

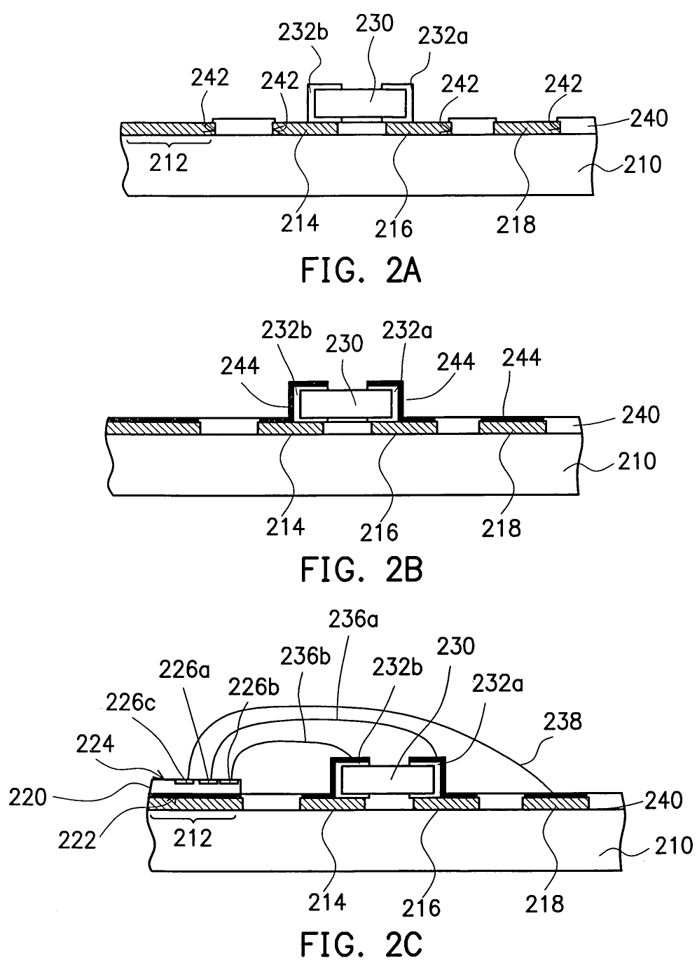

FIGS. 2A˜2C are a schematic illustrating the progression of a manufacturing process of a wire bonding package in accordance with an embodiment of the present invention. Referring to FIG. 2A, a carrier 210 is provided. The carrier 210 can be, for example, a substrate which has a surface having a die bonding area 212, and a plurality of bonding pads including at least a power pad 216, a ground pad 214 and a signal pad 218 are disposed on the surface of the carrier 210. In addition, the power pad 216 and the ground pad 214 are disposed outside the die bonding area 212, and are formed, for example, by portions of the power ring (not shown) and a ground ring (not shown) around the die bonding area 212, respectively. The signal pad 218 is farther from the die bonding area 212 than the power pad 216 and the ground pad 214. The power pad 216, the ground pad 214 and the signal pad 218 are formed, for example, by a patterned conductive layer, and the surface of the patterned conductive layer can be covered with a patterned solder mask layer 240. The solder mask layer 240 has a plurality of openings 242 which expose the surfaces of the power pad 216, the ground pad 214 and the signal pad 218, respectively.

Referring to FIG. 2A, in the preferred embodiment, a passive component 230 is disposed between the power pad 216 and the ground pad 214. The passive component 230 has at least two electrodes 232a and 232b which can be bonded on the surfaces of the power pad 216 and the ground pad 214 by surface mount technology (SMT) for reducing signal noise crosstalk and maintaining quality of signal transmission. The passive component 230 can be, for example, an inductor or a capacitor, and the material of the electrodes 232a and 232b can be, for example, Sn—Pb alloy.

Next, referring to FIG. 2B, a metal layer 244 is formed on the surfaces of the electrodes 232a and 232b, and exposed surfaces of the power pad 216, the ground pad 214 and the signal pad 218 for avoiding oxidation of the contacts 214, 216 and 218. The material of the metal layer 244 can be, for example, nickel, gold or alloy thereof, which can be formed by an electroplating method. In addition, the material of the metal layer 244 has a good wire bonding property with a gold wire for improving the reliability of the subsequent wire bonding process.

Referring to FIG. 2C, a die 220 is disposed on the surface of the carrier 210, and bonded on the die bonding area 212 with the backside 222 of the die 220. The active surface 224 of the die 220 has a plurality of die pads 226 which are respectively corresponding to the power pad 216, the ground pad 214 and the signal pad 218.

Referring to FIG. 2C, in order to reduce the length of the first conductive wires 236a and 236b, at least one end of the first conductive wire 236a is connected to the electrode 232a of the passive component 230, wherein the two ends of the first conductive wire 236a are connected to the die pad 226a of the die 220 and the electrode 232a of the passive component 230. The two ends of another first conductive wire 236b are connected to the die pad 226b of the die 220 and the electrode 232b of the passive component 230. Because the first conductive wire 236a does not cross over the passive component 230, but directly be bonded to the electrode 232a of the passive component 230, the length of the first conductive wire 236a is reduced, and the path of signals going through the first conductive wire 236a can be shortened. Therefore, the electrical performance of the die 220 is improved and the layout spaces of neighboring conductive wires are increased. In addition, two ends of the second conductive wire 238 can be connected to the die pad 236c of the die 220 and the signal pad 218 of the carrier 210, respectively. The second conductive wire 238 can cross over the passive component 230 thereby not touching the electrodes 232a and 232b of the passive component 230.

From the above descriptions, the manufacturing process of package substrate of the present invention is firstly disposing at least one passive component between the power pad and the ground pad of the carrier, wherein two electrodes of the passive component connecting to the power pad and the ground pad, respectively; and then forming a metal layer on the electrodes of the passive component and exposed surfaces of the power pad, the ground pad and the signal pad.

The manufacturing process of package substrate of the present invention has at least following advantages:
(1) A metal layer is formed on the electrode surfaces of the passive component and exposed surfaces of the power pad, the ground pad and the signal pad by performing an electroplating step. An end of the conductive wire is directly connected to an electrode of the passive component. Thus, the yield and reliability of chip package can be effectively improved.
(2) An end of the conductive wire is directly connected to an electrode of the passive component; therefore, the length of the conductive wire is reduced, and the signal transmission path going through the conductive wire is shortened. Accordingly, the electrical performance of the chip package is improved and the layout spaces of neighboring conductive wires are increased.

Although the present invention has been described in terms of exemplary embodiments, it is not limited thereto. Rather, the appended claims should be constructed broadly to include other variants and embodiments of the invention which may be made by those skilled in the field of this art without departing from the scope and range of equivalents of the invention.

1. A manufacturing process of a chip package, at least comprising:
providing a carrier which has a surface, a power pad and a ground pad, the surface of the carrier having a die bonding area, the power pad and the ground pad disposed on the surface of the carrier and outside the die bonding area;
disposing at least one passive component between the power pad and the ground pad, the passive component having at least two electrodes which are connected to the power pad and the ground pad respectively;
forming a metal layer on surfaces of the electrodes and exposed surfaces of the power pad and the ground pad;
disposing a die at the die bonding area on the surface of the carrier, the die having an active surface and a backside, the die having a plurality of die pads formed on the active surface; and
connecting two ends of at least one first conductive wire to one of the die pads of the die and to one of the electrodes of the passive component respectively.

2. The manufacturing process of claim 1, further comprising forming a dielectric material, the dielectric material covering the die, the passive component and the first conductive wire.

3. The manufacturing process of claim 1, wherein the carrier further has a signal pad, and the signal pad is disposed outside the die bonding area and farther from the die bonding area than the power pad and the ground pad.

4. The manufacturing process of claim 3, wherein the metal layer is formed on an exposed surface of the signal pad.

5. The manufacturing process of claim 3, further comprising connecting two ends of at least one second conductive wire to another one of the bonding pads of the die and to the signal pad respectively, the second conductive wire crossing over the passive component.

6. The manufacturing process of claim 5, further comprising forming a dielectric material, the dielectric material covering the die, the passive component, the first conductive wire and the second conductive wire.

7. The manufacturing process of claim 1, wherein prior to the step of disposing the passive component on the carrier, further comprising a step of forming a patterned solder mask layer on the surface of the carrier, the patterned solder mask layer exposing surfaces of the die bonding area, the power pad and the ground pad.

8. The manufacturing process of claim 1, wherein the metal layer is formed by electroplating.

9. The manufacturing process of claim 1, wherein the material of the metal layer is selected from a group consisting of nickel, gold and alloy thereof.

10. The manufacturing process of claim 1, wherein the passive component is selected from a group consisting of an inductor and a capacitor.

11. A manufacturing process of a package substrate, at least comprising:
providing a substrate;
forming a patterned conductive layer on a surface of the substrate, the patterned conductive layer having a power pad, a ground pad and a signal pad;
disposing at least one passive component between the power pad and the ground pad, the passive component having at least two electrodes which are connected to the power pad and the ground pad respectively; and
forming a metal layer on surfaces of the electrodes and exposed surfaces of the power pad, the ground pad and the signal pad.

12. The manufacturing process of claim 11, wherein after the step of forming the patterned conductive layer, further comprising the step of forming a patterned solder mask layer on the surface of the substrate, the patterned solder mask layer exposing surfaces of the power pad, the ground pad and the signal pad.

13. The manufacturing process of claim 11, wherein the material of the metal layer is selected from a group consisting of nickel, gold and alloy thereof.

14. The manufacturing process of claim 11, wherein the passive component is selected from a group consisting of an inductor and a capacitor.

15. A manufacturing process of a package substrate, at least comprising:
providing a substrate, comprising a surface and a plurality of bonding pads, wherein the bonding pads are disposed on the surface of the substrate;
disposing at least one passive component between the bonding pads, the passive component having at least two electrodes which are respectively connected to the bonding pads; and
forming a metal layer on surfaces of the electrodes and exposed surfaces of the bonding pads.

16. The manufacturing process of claim 15, wherein after providing the substrate, further comprising the step of forming a patterned solder mask layer on the surface of the carrier, the patterned solder mask layer exposing the surfaces of the bonding pads.

17. The manufacturing process of claim 15, wherein the metal layer is formed by electroplating.

18. The manufacturing process of claim 15, wherein the material of the metal layer is selected from a group consisting of nickel, gold and alloy thereof.

19. The manufacturing process of package substrate of claim 15, wherein the passive component is selected from a group consisting of an inductor and a capacitor.

20. A package substrate adapted to carry a die of a wire bonding type, the package substrate at least comprising:
a substrate having a surface, a power pad, a ground pad and a signal pad, wherein the surface of the substrate having a die bonding area, the power pad, the ground pad and the signal pad disposed outside the die bonding area;
at least one passive component disposed between the power pad and the ground pad, the passive component having at least two electrodes which are connected to the power pad and the ground pad respectively; and
a metal layer formed on exposed surfaces of the electrodes and exposed surfaces of the power pad, the ground pad and the signal pad.

21. The package substrate of claim 20, further comprising the step of forming a patterned solder mask layer on the surface of the substrate, the patterned solder mask layer exposing the surfaces of the power pad, the ground pad and the signal pad.

22. The package substrate of claim 20, wherein the material of the metal layer is selected from a group consisting of nickel, gold and alloy thereof.

23. The package substrate of claim 20, wherein the passive component is selected from a group consisting of an inductor and a capacitor.
